(19) United States
(12) Patent Application Publication
(10) Pub. No.: US 2026/0105481 A1
(43) Pub. Date: Apr. 16, 2026

(54) REWARD-BASED CONTENT SHARING SYSTEM USING VIRTUAL CURRENCY ISSUANCE SCHEME

(71) Applicants: Koan Hyun CHO, New York, NY (US); Joo Hyung EOM, California, CA (US)

(72) Inventors: Koan Hyun CHO, New York, NY (US); Joo Hyung EOM, California, CA (US)

(21) Appl. No.: 19/116,373

(22) PCT Filed: Sep. 15, 2023
(86) PCT No.: PCT/KR2023/013947

§ 371 Date: Mar. 28, 2025

(30) Foreign Application Priority Data
Sep. 30, 2022 (KR) 1020220125655

(51) Int. Cl. G06Q 30/0207; G06Q 20/36

(52) U.S. Cl. CPC G06Q 30/0215; G06Q 20/363

(57) ABSTRACT

The present disclosure relates to a reward-based content sharing system using a virtual currency issuance method, in which a dedicated virtual currency is issued and paid to a content provider as a reward when content is shared, and some of the content is provided as paid content that can only be purchased with the dedicated virtual currency and the system includes a member registration unit that registers content providers or content consumers as members and registers each member's electronic wallet; a content management unit that uploads content according to the request of the content provider and provides the uploaded content to the content consumer for sharing; a sharing amount collection unit that collects the amount of sharing of each content; a dedicated currency management unit that issues a dedicated virtual currency (hereinafter, “dedicated currency”) for transactions related to the content, but issues the dedicated virtual currency only when a reward is paid for sharing the content; a sharing reward calculation unit that calculates the amount of reward for each content based on the amount of sharing of each content; and a sharing reward payment unit that pays the amount of reward for sharing each content to the content provider of the corresponding content in the form of the dedicated currency, but issues the dedicated currency through the dedicated currency management unit. With the above-mentioned system, even if free content is shared, a dedicated virtual currency is issued and paid to the content provider as reward, and by purchasing paid content only with the dedicated virtual currency, the economic burden on consumers can be reduced, and the concentration on content can be increased by not forcing viewing of advertisements, and fair reward can be provided with transparent reward standards.

### FIELD

The present invention relates to a reward-based content sharing system using a virtual currency issuance method, in which, when content is shared, a dedicated virtual currency is issued and paid as reward to the content provider, and some of the content is provided as paid content that can only be purchased with the dedicated virtual currency.

In addition, the present invention relates to a reward-based content sharing system using a virtual currency issuance method, which rewards content providers according to the amount of sharing when content is shared, and determines the amount of dedicated virtual currency according to the amount of content shared compared to the total amount of content shared.

### BACKGROUND

In general, as the Internet has become widely distributed worldwide and information sharing using the Internet has become widespread, content in the form of text, images, videos, audio, etc. has been shared, and in particular, there have been various attempts to provide reward to content providers who provide meaningful content.

The currently representative reward methods can be summarized into the following three [Patent Documents 1, 2].

First, content consumers purchase points with cash, and then pay points equivalent to the file size of the content shared by the content provider to consume the content. Then, the content provider cashes out the points they have received. This method is widely used to share files through web hard.

Next, content providers insert advertisements into the content shared on the platform and display them. In other words, in this method, like YouTube, the platform operator and the content provider share the revenue from the advertisement.

Next, viewers who watch real-time/streaming content directly pay the content provider the points they purchased with cash as reward. Then, the content provider exchanges them for cash. An example of this method is used in Afreeca TV, etc.

However, these existing reward methods do not completely solve the following problems.

First, by simply providing points in proportion to the file size of the content,
there is a problem that if the content provider produces the file size unnecessarily large and provides it, consumers who consume the content have to pay unnecessary point.

Next, by inserting advertisements for reward, there is a problem that the concentration on content consumption is reduced, and the fatigue and aversion to advertisements are increased, thereby offsetting the advertising effect.

Next, there is a problem that the reward ratio and criteria for advertising revenue are not transparent. In other words, there is a tendency for it to be biased towards platform operators, and for profit distribution to be concentrated only on some popular content.

Next, there is a problem that the economic burden on content consumers increases due to excessive commercialization. These also results in social problems.

Therefore, a new technology is needed to solve these problems, that is, transparent reward criteria to all content providers that reduces the economic burden on consumers, increases concentration on content by not forcing them to watch advertisements while watching content, and provides fair reward is needed.

### PRIOR ART

(Patent Document 1) Korean Patent Publication No. 10-2312810 (Publication date: Oct. 13, 2021)
(Patent Document 2) Korean Patent Publication No. 10-2134671 (Publication date: Jul. 16, 2020)

### SUMMARY

The purpose of the present invention is to solve the above-described problems, and to provide a reward-based content sharing system using a virtual currency issuance method, in which, when content is shared, a dedicated virtual currency is issued and paid as a reward to the content provider, and some of the content is provided as paid content that can be purchased only with the dedicated virtual currency.

In addition, the purpose of the present invention is to provide a reward-based content sharing system using a virtual currency issuance method, in which, when content is shared, the content provider is rewarded according to the amount of sharing, and the amount of the dedicated virtual currency is determined according to the amount of sharing of the content compared to the total amount of content shared.

In particular, the purpose of the present invention is to provide a reward-based content sharing system using a virtual currency issuance method, in which the amount of sharing of the content is determined according to the amount of data consumed by the content consumer, the consumption time, and the playback rate for the provided content.

In order to achieve the above object, the present invention relates to a reward-based content sharing system using a virtual currency issuance method, and is characterized by including a member registration unit that registers content providers or content consumers as members and registers each member's electronic wallet; a content management unit that uploads content according to the request of the content provider and provides the uploaded content to the content consumer for sharing; a sharing amount collection unit that collects the amount of sharing of each content; a dedicated currency management unit that issues a dedicated virtual currency (hereinafter, “dedicated currency”) for transactions related to the content, but issues the dedicated virtual currency only when a reward is paid for sharing the content; a sharing reward calculation unit that calculates the amount of reward for each content based on the amount of sharing of each content; and a sharing reward payment unit that pays the amount of reward for sharing each content to the content provider of the corresponding content in the form of the dedicated currency, but issues the dedicated currency through the dedicated currency management unit.

In addition, the present invention is characterized in that, in a reward-based content sharing system using a virtual currency issuance method, the system further includes a paid payment unit that pays the paid amount when a paid member is registered through the member registration unit or paid content is purchased through the content management unit, but pays the paid amount only with the dedicated currency.

In addition, the present invention is characterized in that, in a reward-based content sharing system using a virtual currency issuance method, the sharing amount collection unit calculates the sharing amount of each content, using at least one of a first method calculating the sharing amount by the amount of data downloaded for the content, a second method calculating the sharing amount by the time consumed for the content, and a third method calculating the sharing amount by the rate at which the content is played.

In addition, the present invention is characterized in that, in a reward-based content sharing system using a virtual currency issuance method, the content is classified by type, and the type of the content includes at least one of text, image, audio, and video.

In addition, the present invention is characterized in that, in a reward-based content sharing system using a virtual currency issuance method, the sharing amount collection unit calculates the sharing amount of each content by accumulating the sharing amount of all the times the content was viewed.

In addition, the present invention is characterized in that, in a reward-based content sharing system using a virtual currency issuance method, if the type of the content is text or image, the sharing amount collection unit calculates the sharing amount t(k,j) based on the consumption time according to the second method for the jth viewing of the content Ck by the following Equation 1.

$$\text{?} \qquad [ Equation 1 ]$$

$$\text{?} \text{indicates text missing or illegible when filed}$$

Wherein, t_{LE}(k,j) and t_{AL}(k,j) are the time when the last usage operation event occurred on the content Cₖ and the time when the content Cₖ is completely loaded on the client, Δₜ₀ represents a predefined idle time, and c is a coefficient that applies the idle time.

In addition, the present invention is characterized in that, in a reward-based content sharing system using a virtual currency issuance method, if the content is text or an image, the sharing amount collection unit estimates the playback rate as the ratio of the portion displayed on the screen among the entire text or image of the content.

In addition, the present invention is characterized in that, in a reward-based content sharing system using a virtual currency issuance method, the sharing reward calculation unit calculates the reward amount of each content in proportion to the sharing amount of the content compared to the total sharing amount.

In addition, the present invention is characterized in that, in a reward-based content sharing system using a virtual currency issuance method, the sharing reward calculation unit calculates the reward amount Rₖ of the content Cₖ by the following Equation 2.

$$\text{?} \qquad [ Equation 2 ]$$

$$\text{?} \text{indicates text missing or illegible when filed}$$

Wherein, R₀ is a pre-determined reference amount expressed in units of the dedicated currency, w₁, w₂ and w₃ are pre-determined weights, Dk, Tk, Pk are the sharing amounts of the first to third methods, respectively, and M(D), M(T), M(P) represent the total sharing amounts of the first to third methods, respectively.

In addition, the present invention is characterized in that, in the reward-based content sharing system using a virtual currency issuance method, the sharing reward payment unit pays the calculated reward amount for each content to the content provider of each content and deducts a certain percentage of the reward amount as a fee.

In addition, the present invention is characterized in that, in a reward-based content sharing system using a virtual currency issuance method, the sharing reward calculation unit sets the reference amount R₀ in proportion to the number of users.

### EFFECT OF THE INVENTION

As described above, according to the reward-based content sharing system of the virtual currency issuance method according to the present invention, even if free content is shared, a dedicated virtual currency is issued and paid as a reward to the content provider, and by purchasing paid content only with the dedicated virtual currency, the economic burden on consumers can be reduced, and the concentration on content can be increased by not forcing viewing of advertisements, and fair reward can be provided with transparent reward standards.

In addition, according to the reward-based content sharing system of the virtual currency issuance method according to the present invention, by determining the amount of dedicated virtual currency according to the amount of content shared compared to the total amount of content shared, the amount of reward per content decreases as more content is consumed overall, so the effect of controlling the amount of virtual currency issuance is obtained.

In addition, according to the reward-based content sharing system of the virtual currency issuance method according to the present invention, the effect of calculating the amount of content shared more accurately is obtained by paying reward for providing content according to the amount of content consumed, consumption time, playback rate, etc.

### BRIEF DESCRIPTION OF THE DRAWINGS

FIG. 1 is a block diagram of the overall system for implementing the present invention.

FIG. 2 is a block diagram of the configuration of a reward-based content sharing system using a virtual currency issuance method according to one embodiment of the present invention.

### DETAILED DESCRIPTION

Hereinafter, specific details for implementing the present invention will be described according to the drawings.

In addition, in describing the present invention, the same parts are given the same reference numerals, and their repeated descriptions are omitted.

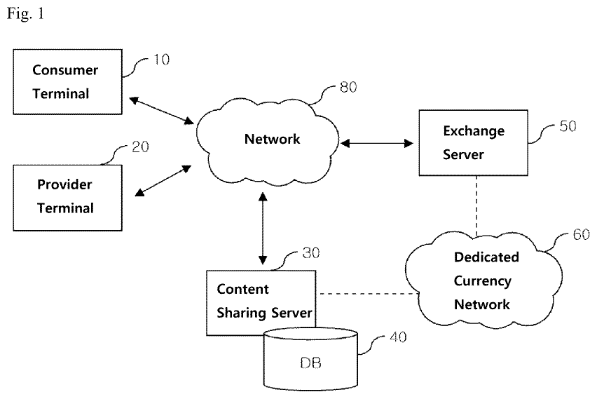

First, the configuration of the overall system according to an embodiment of the present invention will be described with reference to FIG. 1.

As shown in FIG. 1, the overall system according to an embodiment of the present invention is composed of a consumer terminal (10) used by a consumer, a provider terminal (20) used by a content provider, a content sharing server (30) providing a content sharing service, and a dedicated currency network (60) that records transactions of dedicated virtual currency in a blockchain network. In addition, the system may further include an exchange server (50) that relays virtual currency transactions, or a database (40) that stores content, etc. In addition, the consumer terminal (10), the provider terminal (20), the content sharing server (30), the exchange server (50), etc. are connected to a network (80) to perform data communication.

First, the consumer terminal (10) is a computing terminal used by content consumers, and is a terminal equipped with typical computing functions such as a smartphone, PC, laptop, phablet, tablet PC, etc. In particular, the consumer terminal (10) is a terminal on which a web browser, an application, or a mobile application (or app, application) can be installed and executed.

In particular, a client (not shown) that is linked up to a content sharing server (30) is installed on the consumer terminal (10), so that the client and the server (30) can be linked up to provide a content sharing service. In addition, preferably, the client and the content sharing server (30) are built as a client-server system, so that the functions of the entire system can be divided according to the performance of the client or the amount of communication with the server. Therefore, in the following description, the work performed by the consumer terminal (10) is performed by the content consumer through the client (or application) (linked up to the server).

Specifically, the consumer terminal (10) can access the content sharing server (30) and consume the content. The content can be in various forms such as text, image, video, and audio.

In addition, the consumer terminal (10) can use the content for free, and can also use the content for a fee by joining a paid membership or purchasing the paid content. In particular, when the consumer terminal (10) uses the content for a fee, it pays the fee using a dedicated virtual currency (or dedicated currency).

In addition, the consumer terminal (10) can access the exchange server (50) and purchase the dedicated virtual currency (or dedicated currency).

Next, the provider terminal (20) is a computing terminal used by the content provider, and is a terminal equipped with a typical computing function such as a PC, laptop, smartphone, phablet, or tablet PC. In particular, the provider terminal (20) is a terminal on which an application (or a mobile application) can be installed and executed.

In particular, a client (not shown) that is linked up to a content sharing server (30) is installed in the provider terminal (20), so that the client and the server (30) can be linked up to use the content sharing service. In addition, preferably, the client and the content sharing server (30) are built as a client-server system, so that the functions of the entire system can be shared according to the performance of the client or the amount of communication with the server. Therefore, in the following description, the work performed by the provider terminal (20) is performed by the content provider through the client (or application) (linked up to the server).

Specifically, the provider terminal (20) registers as a member in the content sharing server (30) to create a member account, and creates or registers an electronic wallet in the member account. The electronic wallet can be created in the provider terminal (20). At this time, an electronic wallet that has already been created can be registered and used. In addition, it can be created in the content sharing server (30) and managed by the server.

In addition, the provider terminal (20) can access to the content sharing server (30) and upload and provide content. The content can be in various forms such as text, image, video, and audio.

In addition, when the content provided by the provider terminal (20) is shared, the provider terminal receives reward for the shared content according to established regulations. In particular, the provider terminal (20) is paid in dedicated currency, and the paid dedicated currency is stored in an electronic wallet.

Next, the content sharing server (30) is a server that provides a content sharing service and provides the service by linking up with the consumer terminal (10) or the provider terminal (20) or its client. In particular, the content sharing server (30) and the client can be built according to the configuration method of the server-client system. In other words, the functions of the entire system can be divided according to the performance of the client or the amount of communication with the server.

Specifically, the content sharing server (30) registers and manages content providers or content consumers as members, and creates (or registers) and manages an electronic wallet for each content provider or content consumer. A dedicated virtual currency can be stored and managed in the electronic wallet.

In addition, the content sharing server (30) uploads content according to the request of each content provider and provides the content. That is, the provided content is shared with the content consumers. The content can be classified according to the form, such as text, image, video, audio, etc. In addition, the content is classified as a paid or free service.

In addition, the content sharing server (30) pays reward to the corresponding content provider as the dedicated virtual currency according to the amount of each content shared. In particular, the reward is made by transferring the dedicated virtual currency to the electronic wallet of the corresponding content provider.

In addition, the content sharing server (30) issues and manages a dedicated virtual currency (or dedicated currency) used in connection with the content. In particular, it manages a dedicated currency network (60) for recording transactions of the dedicated virtual currency. In addition, the content sharing server (30) issues a dedicated virtual currency only when paying reward to the content provider.

In addition, the content sharing server (30) receives a portion of the amount of the dedicated virtual currency rewarded to the content provider as a fee.

In addition, the content sharing server (30) can act as an agent for transactions of the dedicated virtual currency.

That is, the content sharing server (30) can act as an agent for purchasing a dedicated virtual currency for payment according to the request of the content consumer. That is, the content sharing server (30) can process payment for the purchase amount of the dedicated virtual currency using a normal payment method (bank transfer, credit card, simple payment, etc.), act as an agent for purchasing the dedicated virtual currency of the corresponding amount through an exchange, and store it in the electronic wallet of the content consumer.

In addition, the content sharing server (30) can cash out the provider's dedicated currency or exchange it for another virtual currency according to the request of the content provider.

In addition, the content sharing server (30) can directly run a virtual currency exchange server (50) or provide (act as an agent for) a transaction service for virtual currency to the content provider or content consumer by linking up with the virtual currency exchange server (50).

Next, the exchange server (50) is a server that runs a normal virtual currency exchange and provides a transaction service for virtual currency. In particular, the exchange server (50) provides a virtual currency transaction service for the dedicated currency based on the dedicated currency network (60). That is, the user can exchange the dedicated currency for another virtual currency or cash it out for general currency at the virtual currency exchange of the exchange server (50).

Next, the dedicated currency network (60) is configured as a blockchain network for recording transactions of the dedicated currency. In particular, the dedicated currency network (60) is configured in the form of a blockchain network for general virtual currency.

Next, the database (40) may be configured as a member information DB (41) that stores member information and electronic wallet information of content providers and consumers, a content DB (42) that stores content, and a sharing statistics DB (43) that stores statistical information on shared content. However, the configuration of the above database (40) is only a desirable example, and in developing a specific device, it may be configured in a different structure according to the database construction theory, taking into account the ease and efficiency of access and search.

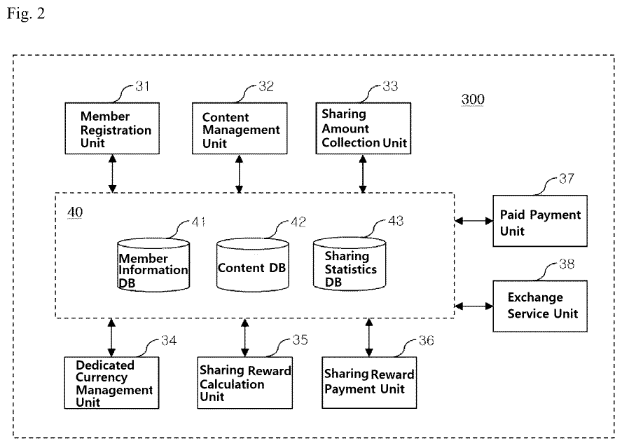

Next, the configuration of the reward-based content sharing system (300) of the virtual currency issuance method according to one embodiment of the present invention will be described in more detail with reference to FIG. 2. The content sharing system according to the present invention can be implemented as a server-client system, etc., consisting of a client and a content sharing server (30), as described above.

As shown in FIG. 2, the reward-based content sharing system (300) of the virtual currency issuance method according to one embodiment of the present invention is composed of a member registration unit (31) for registering members such as content providers/consumers, a content management unit (32) for uploading and providing content, a sharing amount collection unit (33) for collecting statistical information such as the amount of content shared, a dedicated currency management unit (34) for issuing and managing dedicated virtual currency, a sharing reward calculation unit (35) for calculating rewards for shared content, a sharing reward payment unit (36) for paying rewards for the sharing, and a paid payment unit (37) for processing paid payments. In addition, it may further include an exchange service unit (38) that provides a virtual currency transaction service.

First, the member registration unit (31) registers content providers or content consumers as members and creates an account (or member account) for each member. At this time, member information such as name and gender can be registered.

In addition, the member registration unit (31) creates or registers an electronic wallet for each member account. Preferably, the member registration unit (31) creates an electronic wallet for the member and stores the electronic wallet on a server. Therefore, the electronic wallet is not stored on the member terminal (10, 20), but is stored on the server (30) and managed on consignment.

The electronic wallet is a typical electronic wallet for storing dedicated virtual currency. That is, content providers receive reward in the form of dedicated virtual currency according to the amount of content they upload, and the dedicated virtual currency as reward is stored in the electronic wallet of the content provider. In addition, when a member purchases content or signs up for a paid membership, a certain amount is paid in the form of dedicated virtual currency in the electronic wallet of the member account.

Next, the content management unit (32) uploads content according to the request of the content provider and provides the uploaded content to general content consumers.

Content can have various forms such as text, image, video, and audio, and is classified into several types according to the form. For example, content is classified into types such as text, image, picture (or video), and audio.

The content management unit (32) provides a typical interface and function for content providers to upload content. For example, it supports content upload tasks, content format tasks, content classification and description tasks (content keywords/tags, titles, summary descriptions, etc.).

In addition, the content management unit (32) provides an interface and its functions so that content consumers can access and use the uploaded content. In addition, it provides an interface and its functions so that content can be accessed and viewed on various platforms such as the web and mobile apps.

Meanwhile, content is divided into free content and paid content. Free content can be viewed by anyone for free without membership registration, and paid content can be viewed only by members (consumers) who have registered and paid for membership. In particular, paid content is provided only when an individual fee (cost) is required or when a paid member (or premium service) is subscribed. Preferably, the paid amount is set and presented in a dedicated currency unit. More preferably, a general currency unit can also be presented, but the general currency unit is presented as a variable amount according to the market price of the corresponding dedicated currency amount. For example, the purchase price of content is set to 0.5 points, and the general currency amount can change to 500 won, 700 won, etc. depending on the market price.

That is, the content management unit (32) controls only content consumers who have registered as members and paid for content to view paid content. To this end, the content management unit (32) holds information on whether each content is paid, whether each member is a paid member, or whether the member has paid for each paid content, and controls it according to the rules (or regulations) of the paid policy determined in advance.

In addition, if a specific content is paid and payment is required for it, the content management unit (32) requests payment from the content consumer through the paid payment unit (37).

Next, the sharing amount collection unit (33) calculates and collects the sharing amount information of each content. Preferably, the sharing amount of each content shared within a predetermined period (or a predetermined cycle) is accumulated and collected.

The amount of sharing for each content refers to the amount of content shared, and can be calculated in the following three ways. In particular, the method of calculating the amount of sharing may differ depending on the type of content.

First, the amount of sharing in the first method is calculated by the amount of data shared. The amount of data shared is collected by the amount of data downloaded. The amount of data downloaded may differ from the amount of data actually consumed. For example, in the case of a video, 100 MB may actually be downloaded, but only 90 MB may be played and consumed. If a content consumer stops watching a video, the amount of download and the amount of consumption may differ. In addition, in the case of text content in units of pages, such as web novels, or image content in scroll format, such as webtoons, the entire content of the corresponding episode is downloaded, but the consumer may only view a portion of it. In this case, the amount of download and the actual amount of consumption may differ.

In addition, the sharing amount of each content is calculated as the cumulative amount of all times the content was viewed. That is, if 10 people (or 10 times) view the content, the sharing amounts of each of the 10 people (or 10 times) are added together.

That is, the sharing amount Dₖ of the first method for the content Cₖ is as follows.

$$\text{?} \qquad [ Equation 1 ]$$

$$\text{?} \text{indicates text missing or illegible when filed}$$

Here, nₖ represents the number of times the content Cₖ is viewed, and d(k,j) represents the data amount of the jth time of the content Cₖ.

Next, the sharing amount of the second method is calculated as the sharing time (or consumption time). The sharing time for the content is collected as the time the content consumer consumes the content.

The sharing amount of the second method is also calculated as the cumulative amount of all times the content is viewed. That is, the sharing amount Tₖ of the second method for content Cₖ is as follows.

$$\text{?} \qquad [ Equation 2 ]$$

$$\text{?} \text{indicates text missing or illegible when filed}$$

here, nₖ represents the number of times content Cₖ is viewed, and t(k,j) represents the viewing time of the jth time content Cₖ is viewed.

If the content is a video or audio, the time spent playing the content is measured to calculate the consumption time. At this time, if the content is played slowly or quickly (at multiple speeds) compared to the original playback speed, the content's playback time (original playback time) and the consumer's consumption time may be different. For example, if played at double speed, the playback time is 1 hour, but the consumption time is 30 minutes.

If the content is text or an image, the consumption time (or viewing time) is calculated by monitoring the event time occurring in the client of the consumer terminal (10). For this purpose, on the client, such as a browser, it is configured to monitor events of the consumer's usage actions (key input, scroll, click, etc.). In the case of a web browser, a script module implementing this function can be executed.

t(k,j) is calculated by the following equation.

$$\text{?} \qquad [ Equation 3 ]$$

$$\text{?} \text{indicates text missing or illegible when filed}$$

here, t_{LE}(k,j) and t_{AL}(k,j) represent the time when the last event (use operation) occurred on content Cₖ and the time when content Cₖ was loaded to the client (browser, application, etc.), respectively.

Also, Δₜ₀ represents a predetermined time (a predetermined idle time), and c is a coefficient that applies the idle time and is a predetermined value.

Next, sharing amount of the third method is calculated by the shared playback rate. The sharing amount for the corresponding content is collected by the playback rate of the consumed portion of the corresponding content. Meanwhile, the shared playback rate of each content can be calculated by the playback rate compared to the total time of the corresponding content. That is, for example, if the content is a total of 60 minutes of video and ½ of the total video is viewed, the playback rate is 50%.

That is, in the third method, j-th playback rate p(k,j) for each content Cₖ is as follows.

$$\text{?} \qquad [ Equation 4 ]$$

$$\text{?} \text{indicates text missing or illegible when filed}$$

here, p₀(k) represents the total playback time of content Cₖ, and pⱼ(k) represents the viewed playback time (actual playback time, playback time watched by the user) in the jth playback of content Cₖ.

Alternatively, as another embodiment, the playback rate p(k,j) can be set by dividing the playback rate into sections and assigning a playback rate value to each section. The playback rate corresponding to each section is set to increase proportionally. That is, it can be applied differently for each section. For example, the playback rate can be divided into sections and the playback rate value can be set within the sections, such as 0.2 for up to 30%, 0.4 for up to 50%, 0.6 for up to 70%, 1.25 for up to 85%, 1.75 for 95%, and 2.5 for 98% or more. That is, it can be configured to reduce the sharing amount for a certain playback rate or lower, and increase the sharing amount for a playback rate or higher.

The concept of the playback rate is a concept of the sharing amount to reflect the qualitative aspect of the content in order to reward for the disadvantage of being calculated only in terms of the quantitative aspect of the shared content. The quantitative sharing time of 10G video is high, but it is expected that the content may be skipped or stopped midway because it is not interesting. In this case, although the 10G content is quantitatively 10G, 50% playback rate is applied, so the actual recognized data is deducted as 5G, which is 50%. On the other hand, if we assume that the 1G content is quantitatively only 1G, but the content is interesting and compelling, showing a playback rate of 100%, then it is necessary to recognize the sharing amount as 1G or 2-3 times more for such content. This can be a means to encourage content producers to create content that content consumers cannot take their eyes off, rather than simply creating content with large capacity and length.

In addition, the sharing amount of each content is calculated as the cumulative amount of all times the content is played. That is, the sharing amount Pₖ of the third method for content Cₖ is as follows.

$$\text{?} \qquad [ Equation 5 ]$$

$$\text{?} \text{indicates text missing or illegible when filed}$$

here, nₖ represents the number of times content Cₖ is viewed, and p(k,j) represents the playback rate of content Cₖ j times.

In addition, in the case of text or image, the playback rate or playback ratio is calculated as the ratio of the portion displayed on the screen among the entire text or image. In the case where the content is composed of text in units of pages such as web novels, the playback rate (or viewing rate) is estimated as the ratio of the pages viewed in the entire page. In addition, in the case of scroll-type image content such as webtoons, the playback rate (or viewing rate) is estimated as the ratio of the area viewed in the entire image area.

Meanwhile, the sharing amount collection unit (33) accumulates and collects the sharing amount of each shared content within a predetermined period (or a predetermined cycle). The corresponding cycle is the same as the reward cycle. Rewards are performed at regular intervals, and the reward amount is calculated based on the accumulated sharing amount of the corresponding period. Therefore, the sharing amount of each content is collected as the sharing amount within the reward period, and these are used when calculating the reward amount.

Next, the dedicated currency management unit (34) manages the blockchain network (or dedicated currency network) (60) that records transactions of dedicated virtual currency (or dedicated currency) and issues dedicated currency. In particular, the dedicated currency management unit (34) issues dedicated currency only when it grants each content provider a reward according to the sharing of each content. The issued dedicated currency is granted to the corresponding content provider and stored in the electronic wallet of the corresponding content provider.

The dedicated currency network (60) is composed of a blockchain network comprising a number of nodes, and a transaction ledger is shared by each node. In addition, information on the issuance and transaction of the dedicated currency is recorded in the transaction ledger of each node. At this time, modules for managing and sharing the transaction ledger are installed in each node.

The dedicated currency management unit (34) performs management tasks such as distributing such modules to each node or standardizing the functions of the modules. Through this, the dedicated currency network (60) is operated so that it operates normally.

In addition, the dedicated currency management unit (34) issues dedicated currency or dedicated virtual currency, but issues dedicated virtual currency according to the reward amount only when rewarding the content provider. Therefore, the issuance amount of the dedicated virtual currency is determined by the reward amount of the content.

Next, the sharing reward calculation unit (35) calculates the reward (or reward amount) of each content according to the sharing amount of each content, but calculates the reward of each content by reflecting the total sharing amount of the entire content.

The total sharing amount of the entire content represents the sum of the sharing amount of the entire content. The total sharing amount M(S) is as follows. That is, M(S) is the sum of the sharing amounts S.

$$\text{?} \qquad [ Equation 6 ]$$

$$\text{?} \text{indicates text missing or illegible when filed}$$

here, N represents the number of contents, and Sⱼ represents the sharing amount of content Cⱼ. As explained above, the sharing amount is calculated by the first method based on the amount of data, the second method based on the consumption time, and the third method based on the playback rate.

The reward or reward amount of each content is calculated as the share amount of the content compared to the total share amount. The reward (or reward amount) Rₖ of the content Cₖ is as follows.

$$\text{?} \qquad [ Equation 7 ]$$

$$\text{?} \text{indicates text missing or illegible when filed}$$

here, R0 is a pre-determined reference amount, expressed in units of dedicated currency. For example, if R₀ is 1 point (dedicated currency), and if it is equal to the total sharing amount of the content, 1 point (dedicated currency) is paid as the share reward amount of the content.

In addition, the sharing amount Sₖ can use any one of the share amounts of the first to third methods above, or can use more than one. Reflecting this, the above Equation is as follows.

$$\text{?} \qquad [ Equation 8 ]$$

$$\text{?} \text{indicates text missing or illegible when filed}$$

here, w₁, w₂, and w₃ are pre-determined weights. That is, the reward is calculated by weighting the corresponding sharing amount compared to the total sharing amount of the first to third methods. In addition, M(D), M(T), and M(P) represent the total sharing amount of data amount (sharing amount of the first method), of consumption time (sharing amount of the second method), and of playback rate (sharing amount of the third method), respectively.

Meanwhile, the sharing reward calculation unit (35) can be set by the number of users sharing the reference amount R₀. That is, the reference amount R₀ can be increased as the number of users increases. Alternatively, the number of users can be divided into sections and the reference amount R₀ can be set in advance (to increase proportionally) for each section.

Meanwhile, preferably, the sharing reward calculation unit (35) calculates the reward differently for each type of content. That is, the total sharing amount is calculated for each type of content, and the reference amount R₀ or the weights w₁, w₂, and w₃ are also set differently for each type. When calculating the total sharing amount, it is calculated based on the content of each type. For example, text content calculates the total of the sharing amounts of texts, and video content calculates the total of the sharing amounts of video. In addition, the reference amount can be set differently, such as 0.5 points for text content and 1 point for video content.

In addition, the sharing reward calculation unit (35) calculates the sharing reward at regular time intervals according to a predetermined regular cycle (or reward cycle), and calculates the reward based on the sharing amount within the period of the cycle. For example, if the reward cycle is 1 month, the sharing amount for 1 month is accumulated and the sharing reward is calculated based on the sharing amount within the period.

Next, the sharing reward payment unit (36) pays the calculated reward amount for each content to the provider of each content. In addition, a certain percentage (predetermined percentage) of the reward amount is deducted as an operating fee.

The sharing reward payment unit (36) controls the payment of the reward amount for each content to the corresponding content provider.

At this time, the sharing reward payment unit (36) requests (controls) the issuance of a dedicated currency equivalent to the corresponding reward amount through the dedicated currency management unit (34), and requests (controls) the storage of the dedicated currency of the corresponding reward amount in the electronic wallet of the corresponding content provider.

In addition, preferably, the sharing reward payment unit (36) requests that a certain percentage (a percentage determined in advance) of the reward amount or a certain amount determined in advance be deducted as an operating fee and paid, and requests (controls) the storage of the dedicated currency of the fee amount in the electronic wallet of the manager.

Preferably, the fee is divided into a system operating fee, a streaming fee, a storage fee, etc. More preferably, the fee is set according to a rule determined in advance within the range of 1% to 10%. In addition, the storage fee is set in proportion to the storage amount of the corresponding content compared to the average storage amount (or total storage amount) of the entire content.

Meanwhile, the sharing reward payment unit (36) performs payment of sharing reward at regular time intervals according to a predetermined regular cycle (or reward cycle). As an example, the reward cycle can be set in cycle units such as 24 hours, 1 week, or 1 month. Therefore, tasks such as calculating sharing reward are performed according to this reward cycle.

In addition, the sharing reward payment unit (36) calculates the distribution amount of each content provider according to a predetermined distribution rule for the paid payment amount, and distributes the dedicated currency of the calculated amount to the content provider. At this time, the sharing reward payment unit (36) transfers the dedicated currency of the calculated amount from the manager's electronic wallet to the content provider's electronic wallet.

Next, the paid payment unit (37) pays the paid amount when signing up for paid membership or purchasing paid content, but pays the paid amount only with the dedicated currency.

That is, the paid payment unit (37) pays the paid amount and transfers the dedicated currency of the paid amount from the electronic wallet of the content consumer or member to the electronic wallet of the manager.

In addition, preferably, the paid payment unit (37) can purchase the dedicated currency on behalf of the content consumer or member. That is, the paid payment unit (37) processes the purchase amount of the dedicated currency (the amount of general currency) using a normal payment method (bank transfer, credit card, simple payment, etc.) and purchases the equivalent amount (or the paid amount) of the dedicated currency from the exchange in the general currency of the paid amount. The purchased dedicated currency is stored in the electronic wallet of the content consumer.

Next, the exchange service unit (38) directly runs the virtual currency exchange server (50), or can link up with the virtual currency exchange server (50) and provide (act as an agent) a transaction service for virtual currency to members such as content providers or content consumers.

Accordingly, the content provider can exchange the dedicated currency accumulated in his/her account or electronic wallet for another virtual currency or cash it out.

Next, the effects of the present invention will be described in more detail.

As explained above, the present invention supports content providers to upload content to the public, and when such content is shared, it pays reward in the form of blockchain cryptocurrency (or dedicated currency) according to the amount of sharing. Therefore, content providers can receive reward for their content by cashing out the dedicated currency received as reward. In addition, content consumers can share content without paying the administrator or watching advertisements.

In addition, the manager who operates the content sharing system receives a portion of the reward paid to the content provider as a fee (e.g., streaming and storage fees, etc.), so that the operating costs can be covered even without receiving advertising costs, etc.

In addition, since the dedicated currency is traded on an exchange like a typical virtual currency, its value can be determined by the supply and demand of the exchange market.

Managers such as system providers provide premium (paid) services, and consumers must purchase dedicated currency to use the paid services. If the content provider offers something for a fee, such as a live sports game or a new movie, the consumer must purchase the dedicated currency. That is, the consumer must purchase the dedicated currency from the content provider who wants to sell the dedicated currency he has in the exchange market.

In addition, the seller may provide a related video to sell the product in the system of the present invention. In this case, the consumer can only view the product video or description without purchasing it, and the seller can obtain the dedicated currency for free. Therefore, the seller can sell at a lower price than the competitors because the additional dedicated currency income comes in. In other words, the seller can earn additional money and lower the price.

In addition, since the demand for the dedicated currency may be greater in the future, some people may purchase the dedicated currency for investment.

In addition, the dedicated currency of the present invention may cause inflation as the sharing of the content increases. The dedicated currency is produced only when there is demand for the content. High demand means high demand for premium content, just like in the capitalist financial system. Therefore, the higher the demand, the more dedicated currency is required.

As described above, the invention made by the inventor has been specifically described according to the embodiment, but the invention is not limited to the embodiment, and it is obvious that various modifications can be made without departing from the gist.

1. A reward-based content sharing system using a virtual currency issuance method, comprising:
a member registration unit that registers content providers or content consumers as members and registers each member's electronic wallet;
a content management unit that uploads content according to the request of the content provider and provides the uploaded content to the content consumer for sharing;
a sharing amount collection unit that collects the amount of sharing of each content;
a dedicated currency management unit that issues a dedicated virtual currency (hereinafter, “dedicated currency”) for transactions related to the content, but issues the dedicated virtual currency only when a reward is paid for sharing the content;
a sharing reward calculation unit that calculates the amount of reward for each content based on the amount of sharing of each content; and
a sharing reward payment unit that pays the amount of reward for sharing each content to the content provider of the corresponding content in the form of the dedicated currency, but issues the dedicated currency through the dedicated currency management unit.

2. The reward-based content sharing system using a virtual currency issuance method of claim 1,
the system further includes a paid payment unit that pays the paid amount when a paid member is registered through the member registration unit or paid content is purchased through the content management unit, but pays the paid amount only with the dedicated currency.

3. The reward-based content sharing system using a virtual currency issuance method of claim 1,
the sharing amount collection unit calculates the sharing amount of each content, using at least one of a first method calculating the sharing amount by the amount of data downloaded for the content, a second method calculating the sharing amount by the time consumed for the content, and a third method calculating the sharing amount by the rate at which the content is played.

4. The reward-based content sharing system using a virtual currency issuance method of claim 3,
the content is classified by type, and the type of the content includes at least one of text, image, audio, and video.

5. The reward-based content sharing system using a virtual currency issuance method of claim 3,
the sharing amount collection unit calculates the sharing amount of each content by accumulating the sharing amount of all the times the content was viewed.

6. The reward-based content sharing system using a virtual currency issuance method of claim 4,
if the type of the content is text or image, the sharing amount collection unit calculates the sharing amount t(k,j) based on the consumption time according to the second method for the jth viewing of the content Cₖ by the following Equation 1,
$$\text{?} \qquad [ Equation 1 ]$$
$$\text{?} \text{indicates text missing or illegible when filed}$$
wherein, t_{LE}(k,j) and t_{AL}(k,j) are the time when the last usage operation event occurred on the content Cₖ and the time when the content Cₖ is completely loaded on the client, Δₜ₀ represents a predefined idle time, and c is a coefficient that applies the idle time.

7. The reward-based content sharing system using a virtual currency issuance method of claim 4,
if the content is text or an image, the sharing amount collection unit estimates the playback rate as the ratio of the portion displayed on the screen among the entire text or image of the content.

8. The reward-based content sharing system using a virtual currency issuance method of claim 4,
the sharing reward calculation unit calculates the reward amount of each content in proportion to the sharing amount of the content compared to the total sharing amount.

9. The reward-based content sharing system using a virtual currency issuance method of claim 8,
the sharing reward calculation unit calculates the reward amount Rk of the content Ck by the following Equation 2,
$$\text{?} \qquad [ Equation 2 ]$$
$$\text{?} \text{indicates text missing or illegible when filed}$$
wherein, R₀ is a pre-determined reference amount expressed in units of the dedicated currency, w₁, w₂ and w₃ are pre-determined weights, Dk, T, P are the sharing amounts of the first to third methods, respectively, and M(D), M(T), M(P) represent the total sharing amounts of the first to third methods, respectively.

10. The reward-based content sharing system using a virtual currency issuance method of claim 9,
the sharing reward calculation unit sets the reference amount R0 in proportion to the number of users.
